(19) United States
(12) Patent Application Publication
(10) Pub. No.: US 2008/0123061 A1
(43) Pub. Date: May 29, 2008

(54) IMAGE-PROJECTION DISPLAY DEVICE

(75) Inventor: Shohei MATSUOKA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/771,007

(22) Filed: Jun. 29, 2007

(30) Foreign Application Priority Data
Jun. 30, 2006 (JP) 2006-181298

(51) Int. Cl. G02B 27/62

(52) U.S. Cl. 353/79

(57) ABSTRACT

An image-projection display device includes an image-projection optical unit, a flat screen, a first mirror which is closest to the image-projection optical unit, a second mirror which is closet to the flat screen.

An angle formed by the second mirror and a normal on the flat screen is defined as an angle α.

An angle formed by the first mirror and a normal on the flat screen is defined as an angle β.

A maximum rotational angle, for adjustment, of the first mirror about an axis which is parallel to the flat screen, and which lies in a plane where the reference principal light ray before and after reflection at the first mirror lies is defined as a maximum adjustable rotational angle C.

The amount of the angle a and that of the angle β are determined so that the following condition is satisfied:

|sin(2α+2β)/cos β sin C|>20 (1)

### BACKGROUND OF THE INVENTION

1. Field of the Invention

The present invention relates to an image-projection display device (rear projection television), and in particular, relates to an image-projection display device in which the rotation (inclination) of an image on the screen can be adjusted in an assembly process.

2. Description of the Prior Art

An image-projection display device (rear projection television) projects a bundle of image-carrying light rays (hereinafter, a bundle of light rays) emitted from an image-projection optical unit onto a screen to be viewed as an image. For the purpose of miniaturizing an image-projection display device, and of reducing the size thereof in the optical axis direction (thinning), a bundle of light rays emitted from the image-projection optical unit is bent by reflection so that the bundle of light rays is made incident on the screen at an oblique angle (not a right angle).

In such an image-projection display device of an oblique-projection type, the optical axis of the image-projection optical unit is bent in an oblique direction with respect to the screen. Therefore when a rotational position adjustment of an image on the screen is carried out at the time of assembly, the image-projection optical unit itself has to be rotated about an axis which does not lie in a horizontal plane nor in a vertical plane.

More specifically, the above-optical axis is a principal light ray of a bundle of light rays, emitted from the image-projection optical unit and being incident on the center of the flat screen, is made incident on the flat screen at an oblique angle, and this optical axis is hereinafter referred to as a reference principal light ray.

However, the image-projection optical unit has a certain amount of weight, so that it is mechanically difficult to rotate the image-projection optical unit about an oblique axis as mentioned above.

### SUMMARY OF THE INVENTION

The present invention provides an image-projection display device which can perform a rotational position adjustment of an image on the screen without rotating the image-projection optical unit about an oblique axis.

The present invention is devised based on the following confirmed by the inventor in the image-projection display device including an image-projection optical unit, a screen, and at least two mirrors which are arranged to bent a bundle of light rays emitted from the image-projection optical unit so that the bundle of light rays are incident on the screen at an oblique angle:

a rotational position adjustment of an image on the screen can be performed by rotating the second mirror from the screen about an axis which is parallel to the screen, and lies in a plane in which the reference principal light ray before and after reflection at the second mirror from the screen lies; and

a trapezoidal deformation (a tilt of the image plane) occurred depending on the rotational position adjustment of an image on the screen can be reduced to an allowable range by determining an angle formed by one of the at least two mirrors which is closest to the screen and the normal on the screen and an angle formed by the second mirror from the screen and the normal on the screen so that these angles satisfy a predetermined relation according to the amount of a maximum adjustable rotational angle.

According to an aspect of the present invention, there is provided an image-projection display device including an image-projection optical unit, a flat screen, a first mirror which is closest to the image-projection optical unit, a second mirror which is closet to the flat screen.

An angle formed by the second mirror and a normal on the flat screen is defined as an angle α.

An angle formed by the first mirror and a normal on the flat screen is defined as an angle β.

A maximum rotational angle, for adjustment, of the first mirror about an axis which is parallel to the flat screen, and which lies in a plane where the reference principal light ray before and after reflection at the first mirror lies is defined as a maximum adjustable rotational angle C.

The amount of the angle a and that of the angle β are determined so that the following condition is satisfied:

|sin(2α+2β)/cos β sin C|>20 (1)

The maximum adjustable rotational angle C is preferably no more than 90′, and the image-projection display device preferably satisfies the following condition:

|sin(2α+2β)/cos β|>0.18 (2)

The maximum adjustable rotational angle C is preferably no more than 60′, and the image-projection display device preferably satisfies the following condition:

|sin(2α+2β)/cos β|>0.35 (3)

The maximum adjustable rotational angle C is preferably no more than 30′, and the image-projection display device preferably satisfies the following condition:

|sin(2α+2β)/cos β|>0.52 (4)

The present disclosure relates to subject matter contained in Japanese Patent Application No. 2006-181298 (filed on Jun. 30, 2006) which is expressly incorporated herein in its entirety.

### BRIEF DESCRIPTION OF THE DRAWINGS

The present invention will be discussed below in detail with reference to the accompanying drawings, in which:

FIG. 1A is a conceptual view illustrating an image-projection display device, according to the present invention;

FIG. 1B is a view illustrating an adjustment of an image on the flat screen; and

FIGS. 2A and 2B are a conceptual view illustrating the principle of the adjustment of an image on the flat screen, according to the present invention.

### DESCRIPTION OF THE PREFERRED EMBODIMENTS

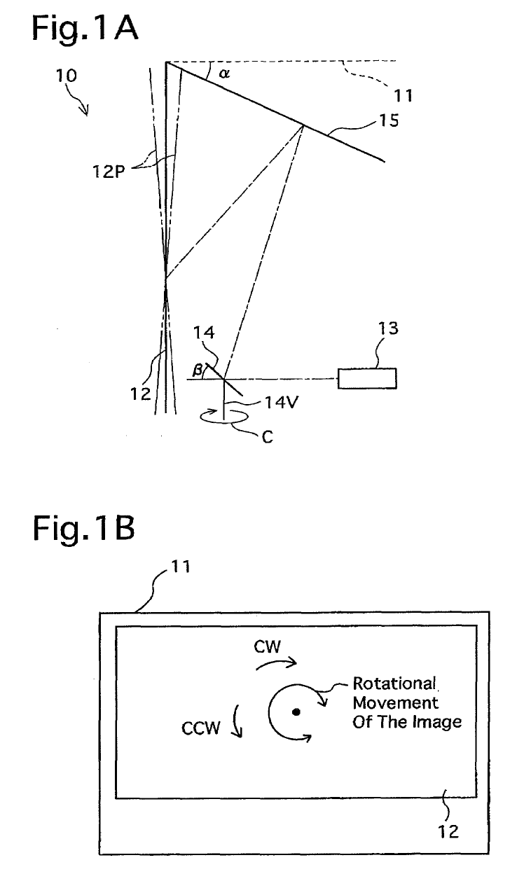

FIG. 1A is the conceptual view illustrating an image-projection display device, according to the present invention.

The image-projection display device 10 is provided with, in a body 11 thereof, a flat screen 12 on a side of the body 11, an image-projection optical unit (image engine) 13, a small mirror 14 (a first mirror) and a fixed mirror 15 (a second mirror).

The fixed mirror 15 is closest to the flat screen 12, and the small mirror 14 is next closest to the flat screen 12, and is closest to the image-projection optical unit 13

A bundle of light rays emitted from the image-projection optical unit 13 is reflected by the small mirror 14. Thereafter, the bundle of light rays is incident on the fixed mirror 15, and is reflected toward the flat screen 12. Finally, the bundle of light rays is incident on the flat screen 12 at an oblique angle.

A plurality of mirrors (i.e., more than two mirrors) may be provided between the image-projection optical unit 13 and the flat screen 12; however, it is specifically essential that the reference principal light ray be incident on the flat screen 12 at a predetermined angle other than the right angle.

In the above described image-projection display device 10, the small mirror 14 is rotatable about a vertical axis 14V parallel to the flat screen 12 so that an image on the flat screen 12 is rotationally moved for the purpose of adjusting the position of an image on the flat screen 12, as shown FIG. 1B which will be explained below. In this case, the amount of rotation of the vertical axis 14V is defined as the maximum adjustable rotational angle C.

Here, in addition to being parallel to the flat screen 12, note that the vertical axis 14V is arranged to lie in a plane where the reference principal light ray before and after reflection at the small mirror 14 lies.

The above-described adjustment can be explained according to FIG. 1B in which the front view of the flat screen 12 with an image I is shown.

In FIG. 1B, when the small mirror 14 is rotated by the vertical axis 14V according to the maximum adjustable rotational angle C, the image I on the flat screen 12 is rotated in a clockwise direction (CW) or in a counter clockwise direction (CCW), so that the position of the image I is adjusted with respect to the flat screen 12.

The maximum adjustable rotational angle C of the vertical axis 14V causes, through the rotation of the small mirror 14, not only a rotational movement of an image on the flat screen 12, but also a trapezoidal deformation (i.e., a tilt of the image plane 12P with respect to the flat screen 12). In FIG. 1A, the tilted image planes 12P are exaggeratedly depicted.

According to FIG. 1A, the following angles are introduced with respect to the large mirror 15, the small mirror 14 and the flat screen 12:

(a) an angle α formed by the large mirror 15 and a normal on the flat screen 12; and

(b) an angle β formed by the small mirror 14 and a normal on the flat screen 12.

By determining the amount of the angle a and that of the angle β according to the maximum adjustable rotational angle C about the vertical axis 14V of the small mirror 14 so that condition (1) is satisfied, a rotational position adjustment of an image on the flat screen 12 is performed, while a trapezoidal deformation (a decline of the image plane 12P) can be reduced to an allowable range.

|sin(2α+2β)/cos β sin C|>20 (1)

As explained, when the rotation of the small mirror 14 is rotated, the tilt of the image plane 12P inevitably occurs. According to the present invention, the angles α and β are determined so that the amount of the tilt of the image plane 12P is made as small as possible compared with the amount of a rotational position adjustment of the image 12P on the flat screen 12.

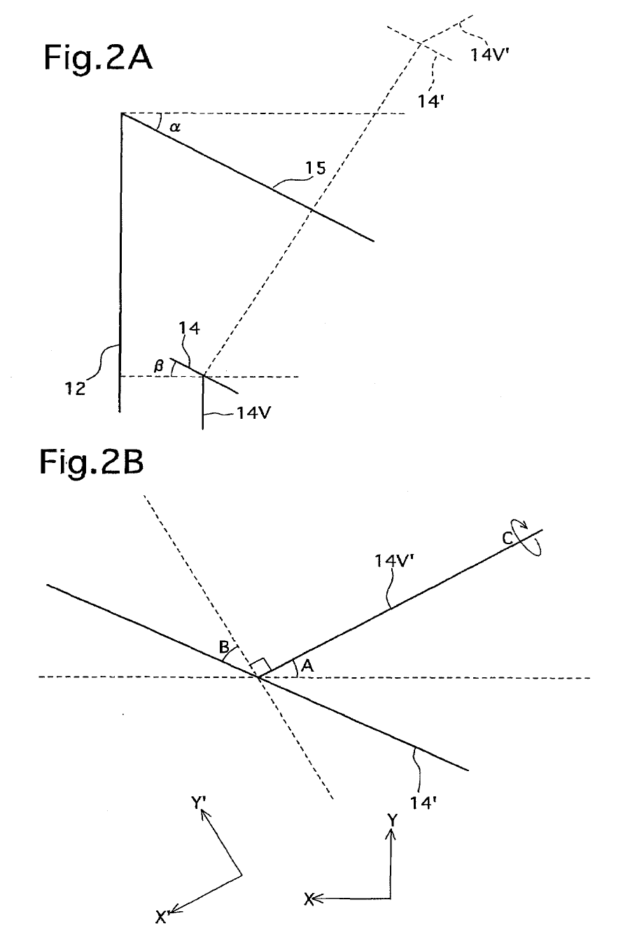

In accordance with FIGS. 2A and 2B, condition (1) will be explained hereinafter.

FIG. 2A shows mirror images (14′ and 14V′: dotted lines) of the small mirror 14 and the vertical axis 14V with respect to the large mirror 15; and the coordinate system with respect to the mirror images (14′ and 14V′) is established as shown in FIG. 2B.

In FIG. 2B, more specifically, the two coordinate systems are established:

an x-y-z coordinate system in which a normal on the flat screen 12 is set to be the x-axis; and

an x′-y′-z′ coordinate system in which the mirror-image vertical axis 14V′ is set to be the x′-axis.

In FIG. 2B, an angle A is formed by a normal on the flat screen 12 and the mirror-image vertical axis 14V′; an angle B is the angle β (FIG. 2A) formed by a normal on the flat screen 12 and the small mirror 14; and the maximum adjustable rotational angle C is indicated about the mirror-image vertical axis 14V′.

Hereinafter, the unit of the angles α, β and C is, unless otherwise specified, [°] (degree).

A two-dimensional vector M which indicates the position of the mirror-image small mirror 14′ is defined with respect to the x′-y′-z′ coordinate system which is orthogonal to the mirror-image vertical axis 14V′ as formula 1:

$$M = ( \begin{matrix}- sin B \\ cos B \\ 0\end{matrix} ) s + ( \begin{matrix}0 \\ 0 \\ 1\end{matrix} ) t \qquad [ Formula 1 ]$$

When the mirror-image small mirror 14′ is rotated by the maximum adjustable rotational angle C about the mirror-image vertical axis 14V′, the position of the mirror-image small mirror 14′ can be rotationally converted with respect to the x′-y′-z′ coordinate system with a two-dimensional vector M′ as shown in formula 2:

$${M}^{′} = ( \begin{matrix}1 & 0 & 0 \\ 0 & cos C & - sin C \\ 0 & sin C & cos C\end{matrix} ) M$$

The above two-dimensional vector M′ defining the position of the mirror-image small mirror 14′ is further converted into the x-y-z coordinate system with a two-dimensional vector M″ of the mirror-image small mirror 14′ as shown in formula 3:

$${M}^{″} = ( \begin{matrix}cos ( 90 + A ) & - sin ( 90 + A ) & 0 \\ sin ( 90 + A ) & cos ( 90 + A ) & 0 \\ 0 & 0 & 1\end{matrix} ) {M}^{′} \qquad [ Formula 3 ]$$

Formula 3 is solved and rearranged, the following formula 4 is obtained:

$${M}^{″} = ( \begin{matrix}- cos A sin B cos C - sin A cos B \\ - sin A sin B cos C + cos A cos B \\ 0\end{matrix} ) s + ( \begin{matrix}0 \\ sin B sin C \\ - cos A sin B cos C - sin A cos B\end{matrix} ) t \qquad [ Formula 4 ]$$

wherein the lower-case letters s and t designate optional values.

According to formula 4, the following can be obtained:

the inclination y/x of the small mirror 14 in the x-y plane of the x-y-z coordinate system:

y/x=((−sin A sin B cos C)+(cos A cos B))/((−cos A sin B cos C)−(sin A cos B)); and

the inclination y/z of the small mirror 14 in the y-z plane of the x-y-z coordinate system:

y/z=(sin B sin C)/((−cos A sin B cos C)−(sin A cos B))

Then, y/x and y/z are differentiated with respect to the maximum adjustable rotational angle C, so that minute inclinations Δy/x and Δy/z with respect to a minute rotation ΔC are obtained as follows:

Δy/x=(sin B cos B sin C)/(−cos A sin B cos C−sin A cos B)

Δy/z=(cos A sin B²−sin A sin B cos B cos C)/(−cos A sin B cos C−sin A cos B)

(Δy/z)/(Δy/x)=(cos A sin B−sin A cos B cos C)/(cos B sin C) sin(A−B)/cos B sin C−sin A cos B(1−cos C)/(cos B sin C)

Here, provided that the value of “sin A cos B(1−cos C)/(cos B sin C” is negligible,

(Δy/z)/(Δy/x)=sin(A−B)/(cos B sin C)

(Δy/z)/(Δy/x) designates the ratio of the inclination of the small mirror 14 on the y-z plane to the inclination thereof on the x-y plane of the x-y-z coordinate system. Namely, the ratio of the amount of rotational movement of the image on the flat screen 12 to the amount of tilt of the image plane 12P in a forward or backward direction.

When the vertical axis 14V is rotated by the maximum adjustable rotational angle C, it is preferable that the occurrence of the tilt of the image plane 12P in a forward or backward direction be within 5 percent. Therefore the adjustment is preferably performed to maintain the following formula:

(Δy/z)/(Δy/x)>20

In other words, this formula indicates that the amount of rotation of the image on the flat screen 12 due to the maximum adjustable rotational angle C is more than twenty times as large as the amount of tilt of the image plane 12P in a forward or backward direction.

The following parameters are provided:

A=90−2α−β; and

B=β

Then, (Δy/z)/(Δy/x) is rewritten as follows:

(Δy/z)/(Δy/x)=sin(2α+2β)/(cos β sin C)>20

Multiplying sin C for both sides of the above formula,

sin(2α+2β)/cos β>20 sin C

According to the embodiment, examples illustrating a rotational angle for to the maximum adjustable rotational angle C of the small mirror 14 about the vertical axis 14V, the amount of a rotational position adjustment of the image 12P on the flat screen 12, and the amount of tilt of the image plane 12P are hereinafter shown.

### EXAMPLE 1

In the case where the maximum adjustable rotational angle C is set to be 90′ as a precondition, the angles α and β can be determined as follows within a range which satisfies condition(1)
α=20°
β=40°

Then, the angles α and β, at the same time, satisfies condition (2) as well as follows:

|sin(2α+2β)/cos β|=0.65

As a result,

the amount of a necessary rotational position adjustment of the image on the flat screen 12=3°; and

the amount of tilt of the image plane 12P=0.12°

Namely, the amount of a rotational position adjustment of the image on the flat screen 12 is twenty five times as large as the amount of tilt of the image plane 12P, i.e., a necessary amount of a rotational position adjustment of the image on the flat screen 12 causes a very little amount of tilt of the image plane 12P.

Furthermore, with the same mirror arrangement, in the case where the maximum adjustable rotational angle C is set to be 60′ as a precondition, the angles α and β satisfies condition (3) as follows:

|sin(2α+2β)/cos β|=0.75

As a result,

the amount of a necessary rotational position adjustment of the image on the flat screen 12=2°; and

the amount of tilt of the image plane 12P=0.046°

Namely, the amount of a rotational position adjustment of the image on the flat screen 12 is forty three times as large as the amount of tilt of the image plane 12P, i.e., a necessary amount of a rotational position adjustment of the image on the flat screen 12 causes a very little amount of tilt of the image plane 12P.

Still further, with the same mirror arrangement, in the case where the maximum adjustable rotational angle C is set to be 30′ as a precondition, the angles α and β satisfies condition (4) as follows:

|sin(2α+2β)/cos β|=1.31

As a result,

the amount of a necessary rotational position adjustment of the image on the flat screen 12=1°; and

the amount of tilt of the image plane 12P=0.007°

Namely, the amount of a rotational position adjustment of the image on the flat screen 12 is a hundred and forty three times as large as the amount of tilt of the image plane 12P, i.e., a necessary amount of a rotational position adjustment of the image on the flat screen 12 causes a very little amount of tilt of the image plane 12P.

### EXAMPLE 2

Similar to Example 1, In the case where the maximum adjustable rotational angle C is set to be 90′ as a precondition, the angles α and β can be determined as follows within a range which satisfies condition (1):

α=25°

β=51.5°

Then, the angles α and β, at the same time, satisfies condition (2) as well as follows:

|sin(2α+2β)/cos β|=1.43

As a result,

the amount of a necessary rotational position adjustment of the image on the flat screen 12=3°; and

the amount of tilt of the image plane 12P=0.055°

Namely, the amount of a rotational position adjustment of the image on the flat screen 12 is fifty five times as large as the amount of tilt of the image plane 12P, i.e., a necessary amount of a rotational position adjustment of the image on the flat screen 12 causes a very little amount of tilt of the image plane 12P.

Furthermore, with the same mirror arrangement, in the case where the maximum adjustable rotational angle C is set to be 60′ as a precondition, the angles α and β satisfies condition (3) as follows:

|sin(2α+2β)/cos β|=1.65

As a result,

the amount of a necessary rotational position adjustment of the image on the flat screen 12=2°; and

the amount of tilt of the image plane 12P=0.021°

Namely, the amount of a rotational position adjustment of the image on the flat screen 12 is ninety five times as large as the amount of tilt of the image plane 12P, i.e., a necessary amount of a rotational position adjustment of the image on the flat screen 12 causes a very little amount of tilt of the image plane 12P.

Still further, with the same mirror arrangement, in the case where the maximum adjustable rotational angle C is set to be 30′ as a precondition, the angles α and β satisfies condition (4) as follows:

|sin(2α+2β)/cos β|=2.86

As a result,

the amount of a necessary rotational position adjustment of the image on the flat screen 12=1°; and

the amount of tilt of the image plane 12P=0.003°

Namely, the amount of a rotational position adjustment of the image on the flat screen 12 is three thousand times as large as the amount of tilt of the image plane 12P, i.e., a necessary amount of a rotational position adjustment of the image on the flat screen 12 causes little amount of tilt of the image plane 12P.

According to the above descriptions, by determining an angle formed by the first mirror and the normal on the flat screen and an angle formed by the second mirror and the normal on the flat screen so that these angles satisfy condition (1), the rotational position adjustment of the image on the flat screen can be performed, while a trapezoidal deformation (a tilt of the image plane) occurred depending on the rotational position adjustment of an image on the screen can be reduced to an allowable range.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. An image-projection display device comprising an image-projection optical unit, a flat screen, a first mirror that is closest to said image-projection optical unit, a second mirror that is closet to said flat screen,
wherein an angle formed by said second mirror and a normal on said flat screen is defined as an angle α;
wherein an angle formed by said first mirror and a normal on said flat screen is defined as an angle β;
wherein a maximum rotational angle, for adjustment, of said first mirror about an axis that is parallel to said flat screen, and that lies in a plane where a reference principal light ray before and after reflection at said first mirror lies is defined as a maximum adjustable rotational angle C; and
wherein the amount of said angle a and that of said angle β are determined so that the following condition is satisfied:

|sin(2α+2β)/cos βsin C|>20

2. The image projection display device according to claim 1, wherein said maximum adjustable rotational angle C is no more than 90′, and
wherein said image-projection display device satisfies the following condition:

|sin(2α+2β)/cos β|>0.18

3. The image projection display device according to claim 1, wherein said maximum adjustable rotational angle C is no more than 60′, and
wherein said image-projection display device satisfies the following condition:

|sin(2α+2β)/cos β|>0.35

4. The image projection display device according to claim 1, wherein said maximum adjustable rotational angle C is no more than 30′, and
wherein said image-projection display device satisfies the following condition:

|sin(2α+2β)/cos β|>0.52
